(19) United States
(12) Patent Application Publication
(10) Pub. No.: US 2023/0267392 A1
(43) Pub. Date: Aug. 24, 2023

(54) Computer System and Method for Predicting Risk Level of Punch Items

(71) Applicant: Procore Technologies, Inc., Carpinteria, CA (US)

(72) Inventors: Carlos Torres, Goleta, CA (US); Nina Kaufman, Castaic, CA (US); Evin Sellin, Santa Barbara, CA (US); Wojciech Peliks, Santa Barbara, CA (US); Mark Weeks, Santa Barbara, CA (US); Arshdeep Kaur, Oxnard, CA (US); Nicholas Murphy, Santa Barbara, CA (US); Fatima Howes, Carpinteria, CA (US)

(21) Appl. No.: 18/158,278

(22) Filed: Jan. 23, 2023

Related U.S. Application Data
(63) Continuation of application No. 16/120,147, filed on Aug. 31, 2018, now abandoned.

(51) Int. Cl. G06Q 10/0631; G06N 5/022

(52) U.S. Cl. CPC G06Q 10/06313; G06N 5/022

(57) ABSTRACT

A computing system such as a back-end platform for construction management software may employ a predictive model to provide individuals responsible for overseeing a construction project with a prediction of a “risk level” for a punch item, which indicates a risk of the punch item not being completed by the punch item's target completion date. Such a predictive model may be defined based on historical-punch-items data. After defining the predictive model, the computing system may receive data defining a given punch item and input such data into the predictive model, which may in turn output a given predicted risk level for the given punch item. Thereafter, the computing system may cause a client station to display an indication of the given predicted risk level for the given punch item.

### CROSS-REFERENCE TO RELATED APPLICATIONS

This application is a continuation of, and claims the benefit of priority under 35 U.S.C. § 120 to, U.S. application Ser. No. 16/120,147, filed on Aug. 31, 2018 and titled “Computer System and Method for Predicting Risk Level of Punch Items,” the contents of which are incorporated by reference herein in their entirety.

### BACKGROUND

A construction project typically includes various different phases, examples of which include an initiation phase, a planning phase, an execution phase, performance and monitoring phases, and a closure phase that may also be referred to as the “punch list” phase (or “defect list” phase in some geographies). During the punch list phase—which typically occurs immediately prior to completion of the construction project—a “punch list” is prepared to list any remaining tasks that must be completed before the construction project can be deemed to have been satisfactory completed and closed out (e.g., tasks not conforming to contract specifications). The individual tasks included on a punch list are typically referred to as “punch items” or “defect items.” (For purposes of this disclosure, the use of the term “punch item” should be understood to cover a “defect item” and/or any other term that may be used to describe a task associated with a construction project). If these punch items are not completed in a timely manner, the individuals responsible for the construction project (e.g., contractors, project managers, etc.) may incur financial loss (e.g., by triggering liability for liquidated damages) and also risk damaging their reputation and/or business relationships.

### Overview

In conventional practice, a punch list for a construction project was a handwritten document that was created and then managed in hard copy form. This approach gave rise to several efficiency issues, including difficulties and delays associated with distributing the hard copy punch list to individuals that were responsible for ensuring that the punch items were completed in a timely manner as well as difficulties associated with managing the execution of the punch items on the punch list across multiple different construction teams or individual workers.

More recently, software technology has become available that allows for a punch list to be created and managed electronically. For example, Procore Technologies, Inc., who is the assignee of the present application, offers construction management software that includes a “Punch List” tool for creating and managing punch lists for a construction project. This software technology has significantly improved the process of creating and managing punch lists over conventional hard-copy approaches. Indeed, not only has such software technology significantly improved the efficiency of creating and managing punch lists, it has also given rise to several new features that were not possible with the conventional hard-copy approaches—including real-time distribution of events related to punch items such as the creation of a new punch item, a status updated to a punch item, or the completion of a punch item.

However, existing software technology for creating and managing punch lists still has certain limitations. For instance, while existing software technology has significantly improved upon the process for creating and managing punch lists, there is still a risk that punch items may not be completed in a timely manner, and there is presently no software technology that provides visibility of this risk. As a result, individuals responsible for a construction project often do not become aware of punch items that are behind schedule until it is too late to rectify the delay, which means that such individuals are exposed to financial loss and damage to their reputation and/or business relationships.

To help improve upon these and other problems with existing software technology for creating and managing punch lists, disclosed herein is software technology that employs a predictive model to provide individuals responsible for overseeing a construction project with a prediction of a “risk level” for each of a plurality of punch items on a punch list, which indicates a risk of the punch item not being completed by the punch item's target completion date.

In accordance with the present disclosure, a back-end platform may first operate in a definition phase during which the back-end platform defines a predictive model that is configured to predict a risk level of a punch item by applying a machine learning technique (e.g., a random forest technique) to historical punch items data that includes (a) punch-item data for past punch items that have completed and (b) labels for each past punch item that indicate when the punch item was actually completed relative to its target completion date, which may be represented as an actual risk level.

Thereafter, the back-end platform may operate in an execution phase during which the back-end platform applies the predictive model to punch-item data for new punch items associated with a construction project (e.g., punch items entered via an interface of front-end construction manage software running on a client station) and then provides the predicted risk levels for the punch items to individuals responsible for the construction project. In this way, the disclosed software technology enables individuals responsible for a construction project to preemptively identify punch items that are at risk of not being completed by their respective target completion dates and then preemptively address these behind-schedule punch items (e.g., by reallocating resources to such punch items) to improve the chances that they will be completed in a timely manner.

In addition, those in the art will understand that the disclosed approach for predicting risk level may be implemented in other construction-related areas. As one possibility, a back-end platform may also be configured to receive data pertaining to submittals, in which case the back-end platform may be configured to use the modeling approaches disclosed herein to evaluate risk for those submittals. For example, a back-end platform may be configured to define and then execute a predictive model that is used to determine whether a submittal is likely to result in late completion. As another example, a back-end platform may be configured to define and then execute a predictive model that is used to determine other areas of risk associated with the submittal, such as the amount of time it takes for a submittal to be approved, the length of time it takes to respond to the submittal, and so forth. Other possible implementations may exist as well.

Accordingly, in one aspect, disclosed herein is a computing system (e.g., a back-end platform for a front-end construction management software application) that is configured to perform at least the following functions: (a) based on historical-punch-items data, defining a predictive model that is configured to receive data defining a punch item as inputs and output a predicted risk level for the punch item, (b) receiving data defining a given punch item; (c) inputting at least the received data defining the given punch item into the predictive model and thereby determining a given predicted risk level for the given punch item that indicates a risk of the given punch item not being completed on time, and (d) causing a client station to display an indication of the given predicted risk level for the given punch item.

In another aspect, disclosed herein is a non-transitory computer-readable medium, where the computer-readable medium is provisioned with software that is executable to cause a computing system to perform functions including: (a) based on historical-punch-items data, defining a predictive model that is configured to receive data defining a punch item as inputs and output a predicted risk level for the punch item, (b) receiving data defining a given punch item; (c) inputting at least the received data defining the given punch item into the predictive model and thereby determining a given predicted risk level for the given punch item that indicates a risk of the given punch item not being completed on time, and (d) causing a client station to display an indication of the given predicted risk level for the given punch item.

In yet another aspect, disclosed herein is a computer-implemented method that involves (a) based on historical-punch-items data, defining a predictive model that is configured to receive data defining a punch item as inputs and output a predicted risk level for the punch item, (b) receiving data defining a given punch item; (c) inputting at least the received data defining the given punch item into the predictive model and thereby determining a given predicted risk level for the given punch item that indicates a risk of the given punch item not being completed on time, and (d) causing a client station to display an indication of the given predicted risk level for the given punch item.

One of ordinary skill in the art will appreciate these as well as numerous other aspects in reading the following disclosure.

### BRIEF DESCRIPTION OF THE DRAWINGS

FIG. 1 depicts an example network configuration in which example embodiments may be implemented.

FIG. 2 depicts a simplified block diagram of an example back-end platform from a structural perspective.

FIG. 3 depicts a flowchart of an example model definition phase that may be carried out to define a predictive model.

FIG. 4 depicts a flowchart of an example model execution phase for a predictive model that is configured to output a predicted risk level for a given punch item.

FIG. 5 depicts an example view of view of a front-end application.

FIG. 6 depicts another example view of a front-end application.

### DETAILED DESCRIPTION

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### I. Example Network Configuration

As discussed above, the present disclosure is generally directed to software technology for managing construction projects. In practice, this software technology may include both front-end construction management software that runs on client stations of individuals responsible for construction projects (e.g., contractors, project managers, etc.) and a back-end platform that interacts with and/or drives the front-end software, which may be operated (either directly or indirectly) by the provider of the construction management software.

In general, such front-end construction management software may enable an individual responsible for a construction project to perform various tasks related to the management of the construction project, which may take various forms. According to some implementations, these tasks may include: project schedule management, quality and safety assurance, project financial management, and field productivity management, as some non-limiting examples. Further, such front-end construction management software may take various forms, examples of which may include a native application (e.g., a mobile application) and/or a web application running on a client station, among other possibilities.

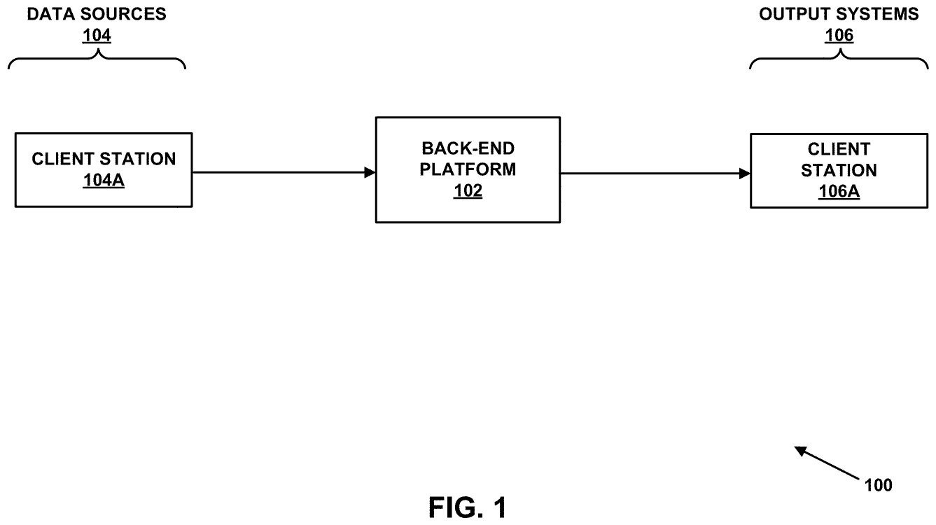

Turning now to the figures, FIG. 1 depicts an example network configuration 100 in which example embodiments may be implemented. As shown, network configuration 100 includes a back-end platform 102 that may be communicatively coupled to one or more data sources 104 and one or more output systems 106 via respective communication paths.

Broadly speaking, back-end platform 102 may comprise one or more computing systems that have been provisioned with software for carrying out one or more of the platform functions disclosed herein, including but not limited to receiving data related to a construction project (broadly referred to herein as “project-related data”), performing data analytics operations on the project-related data received from data sources 104, storing project-related data for future access by output systems 106, and transmitting data and/or instructions that cause one or more output systems 106 to output information related to a construction project. The one or more computing systems of back-end platform 102 may take various forms and be arranged in various manners.

For instance, as one possibility, back-end platform 102 may comprise computing infrastructure of a public, private, and/or hybrid cloud (e.g., computing and/or storage clusters) that has been provisioned with software for carrying out one or more of the platform functions disclosed herein. In this respect, the entity that owns and operates back-end platform 102 may either supply its own cloud infrastructure or may obtain the cloud infrastructure from a third-party provider of “on demand” computing resources, such include Amazon Web Services (AWS) or the like. As another possibility, back-end platform 102 may comprise one or more dedicated servers that have been provisioned with software for carrying out one or more of the platform functions disclosed herein. Other implementations of back-end platform 102 are possible as well.

As described above, back-end platform 102 may be configured to receive project-related data from one or more data sources 104. These data sources—and the project-related data output by such data sources—may take various forms. For instance, as shown in FIG. 1, one type of data source 104 may take the form of client station 104A, which may comprise any computing device that is configured to receive user input related to a construction project (e.g., information entered by a contractor, architect, delivery person, on-site construction worker, estimator or the like) and then send that user input to back-end platform 102 over the respective communication path between client station 104A and back-end platform 102. In this respect, client station 104A may take any of various forms, examples of which may include a desktop computer, a laptop, a netbook, a tablet, a smartphone, and/or a personal digital assistant (PDA), among other possibilities.

While FIG. 1 illustrates a single input client station 104A, it should be understood that back-end platform 102 may be communicatively coupled to a plurality of different client stations 104A that may provide project-related data to back-end platform 102. Further, although not shown, it should be understood that back-end platform 102 may be configured to receive project-related data from other types of data sources as well.

As shown in FIG. 1, back-end platform 102 may also be configured to transmit data and/or instructions that cause one or more output systems 106 to output information related to a construction project. These output systems—and the data and/or instructions provided to such output systems—may take various forms. For instance, as shown in FIG. 1, one type of output system 106 may take the form of client station 106A, which may comprise any computing device that is configured to receive project-related data from back-end platform 102 over the respective communication path between client station 106A and back-end platform 102 and then present such data to a user (e.g., via front-end construction management software running on client station 106A). In this respect, client station 106A may take any of various forms, examples of which may include a desktop computer, a laptop, a netbook, a tablet, a smartphone, and/or a PDA, among other possibilities. Further, it should be understood that some client stations may serve as both an input client station 104A and an output client station 106A, while other client stations may only serve as an output client station 106A.

Along with the project-related data that is output for receipt by client station 106A, back-end platform 102 may also output associated data and/or instructions that define the visual appearance of a front-end interface (e.g., a graphical user interface (GUI)) through which the project-related data is to be presented on client station 106A. Such data and/or instructions for defining the visual appearance of a front-end application may take various forms, examples of which may include Hypertext Markup Language (HTML), Cascading Style Sheets (CSS), and/or JavaScript, among other possibilities. However, depending on the circumstance, it is also possible that back-end platform 102 may output project-related data to client station 106A without any associated data and/or instructions for defining the visual appearance of a front-end interface.

Further, client station 106A may receive project-related data from back-end platform 102 in various manners. As one possibility, client station 106A may send a request to back-end platform 102 for certain project-related data and/or a certain front-end interface, and client station 106A may then receive project-related data in response to such a request. As another possibility, back-end platform 102 may be configured to “push” certain types of project-related data to client station 106A, such as scheduled or event-based alerts, in which case client station 106A may receive project-related data from back-end platform 102 in this manner. As yet another possibility, back-end platform 102 may be configured to make certain types of project-related data available via an API, a service, or the like, in which case client station 106A may receive project-related data from back-end platform 102 by accessing such an API or subscribing to such a service. Client station 106A may receive project-related data from back-end platform 102 in other manners as well.

While FIG. 1 illustrates a single output client station 106A, it should be understood that back-end platform 102 may be communicatively coupled to a plurality of different client stations 106A that may receive data and/or instructions from back-end platform 102. Further, although not shown, it should be understood that back-end platform 102 may be configured to communicate with other output systems 106 as well.

As discussed above, back-end platform 102 may communicate with the one or more data sources 104 and one or more output systems 106 over respective communication paths. Each of these communication paths may generally comprise one or more communication networks and/or communications links, which may take any of various forms. For instance, each respective communication path with back-end platform 102 may include any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path with back-end platform 102 may be wireless, wired, or some combination thereof, and may carry data according to any of various different communication protocols.

Although not shown, the respective communication paths with back-end platform 102 may also include one or more intermediate systems. For example, it is possible that a given data source 104 may send project-related data to one or more intermediary systems, such as an aggregation system, and back-end platform 102 may then be configured to receive the project-related data from the one or more intermediary systems. As another example, it is possible that back-end platform 102 may communicate with a given output system 106 via one or more intermediary systems, such as a host server (not shown). Many other configurations are also possible.

It should be understood that network configuration 100 is one example of a network configuration in which embodiments described herein may be implemented. Numerous other arrangements are possible and contemplated herein. For instance, other network configurations may include additional components not pictured and/or more or less of the pictured components.

### II. Example Platform

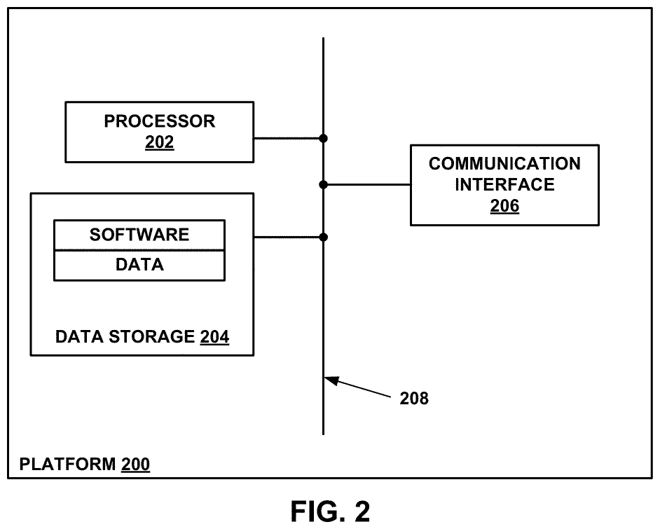

FIG. 2 is a simplified block diagram illustrating some structural components that may be included in an example computing platform 200, which could serve as the back-end platform 102 in FIG. 1. In line with the discussion above, platform 200 may generally comprise one or more computer systems (e.g., one or more servers), and these one or more computer systems may collectively include at least a processor 202, data storage 204, and a communication interface 206, all of which may be communicatively linked by a communication link 208 that may take the form of a system bus, a communication network such as a public, private, or hybrid cloud, or some other connection mechanism.

Processor 202 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 202 could comprise processing components that are distributed across a plurality of physical computing devices connected via a network, such as a computing cluster of a public, private, or hybrid cloud.

In turn, data storage 204 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 204 may comprise computer-readable storage mediums that are distributed across a plurality of physical computing devices connected via a network, such as a storage cluster of a public, private, or hybrid cloud.

As shown in FIG. 2, data storage 204 may be provisioned with software components that enable the platform 200 to carry out the functions disclosed herein. These software components may generally take the form of program instructions that are executable by the processor 202 to carry out the disclosed functions, which may be arranged together into software applications, virtual machines, software development kits, toolsets, or the like. Further, data storage 204 may be arranged to store project-related data in one or more databases, file systems, or the like. Data storage 204 may take other forms and/or store data in other manners as well.

Communication interface 206 may be configured to facilitate wireless and/or wired communication with data sources and output systems, such as data sources 104 and output systems 106 in FIG. 1. Additionally, in an implementation where platform 200 comprises a plurality of physical computing devices connected via a network, communication interface 206 may be configured to facilitate wireless and/or wired communication between these physical computing devices (e.g., between computing and storage clusters in a cloud network). As such, communication interface 206 may take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for wireless and/or wired communication. Communication interface 206 may also include multiple communication interfaces of different types. Other configurations are possible as well.

Although not shown, platform 200 may additionally include one or more interfaces that provide connectivity with external user-interface equipment (sometimes referred to as “peripherals”), such as a keyboard, a mouse or trackpad, a display screen, a touch-sensitive interface, a stylus, a virtual-reality headset, speakers, etc., which may allow for direct user interaction with platform 200.

It should be understood that platform 200 is one example of a computing platform that may be used with the embodiments described herein. Numerous other arrangements are possible and contemplated herein. For instance, other computing platforms may include additional components not pictured and/or more or less of the pictured components.

### III. Example Operations

As discussed above, disclosed herein is software technology that makes use of a predictive model provide individuals responsible for overseeing a construction project with a prediction of a “risk level” for each of a plurality of punch items on a punch list, which indicates a risk of the punch item not being completed by the punch item's target completion date. In accordance with the present disclosure, this predicted model may be configured to (1) receive data defining a given punch item (which may be referred to herein as “punch-item data”) as input and then (2) output a predicted risk level associated with the given punch item. In addition, the predictive model may also optionally be configured to output a confidence level, which indicates a confidence in the predictive model's prediction of the risk level for the given punch item.

The disclosed predictive model may be of various types. In one implementation, the predictive model may be a supervised classification model, which may take various forms. Examples of supervised classification model may include: a random forest model, a gradient boosting model (such as those implemented using the XGBoost library), and a logistic regression model, as some non-limiting examples. The predictive model may also be of various other types as well.

Further, the punch-item data that is received as the predictive model's inputs may take various forms. As one possibility, the punch-item data for a given punch item may include item-specific data, which in turn may comprise various forms of data.

For instance, the item-specific data for a given punch item may comprise “item-type” data that may identify and/or describe the type of the given punch item. As examples, such item-type data may take the form of a title, a category, an alphanumeric code, and/or a textual description of the given punch item. The item-type data for a given punch item may take various other forms as well.

Further, the item-specific data may comprise “item-assignment” data for a given punch item that indicates whether the given punch item has been assigned to an individual who is responsible for completing the given punch item (e.g., a contractor or project manager). As examples, such item-assignment data may include an identification of any assignee of the given punch item and/or the assignee's project role, an identification of any assignor of the given punch item (e.g., an individual that assigned out the punch item, is tasked with overseeing the given punch item, or is otherwise interested in being notified about the status of the given punch item), an identification of priority associated with the given punch item, and/or an indication of the date when the given punch item was assigned to an assignee. The item-assignment data for a given punch item may take various other forms as well.

Further yet, the item-specific data may comprise “item-timing” data for a given punch item that indicates relevant timing information for the given punch item. For instance, the item-timing data may comprise relevant dates for the given punch item, such as a creation date, a start date, a target completion date, an actual completion date, a date the punch item was assigned, a date a notification was sent to an assignee, a date the assignee responded to the punch item, etc. In addition, the item-timing data may include other contextual data that is derived from and/or otherwise associated with the relevant dates for the given punch item, such as an indication of the particular season during which the given punch item is being worked upon (which may be derived based on the start date, target completion date, and/or the geographical location of the given punch item), the particular month(s) of the year during which the given punch item is being worked upon (which may be derived based on the start date and target completion date of the given punch item), any holidays between the start date and the target completion date, the particular day of the week that the given punch item is scheduled to begin (which may be derived based on the start date, target completion date, and/or the geographical location of the given punch item), and/or the particular day of the week that the given punch item is scheduled to be completed (which may be derived based on the target completion date of the given punch item).

Additionally, timing data may be derived for any of the other types of punch-item data described herein. For instance, the date that an assignee is added, notified, or responds to a notification may comprise derived timing data. The item-timing data for a given punch-item data may take various other forms as well.

Still further, the item-specific data for a given punch item may comprise “user comment” data that indicates user commentary about the given punch item. As examples, such user comment data may include a description pertaining to the work to be performed to complete the given punch item (e.g. “fix door frame,” “re-paint trim,”) and/or a status update for the given punch item, among other possibilities. The user comment data for a given punch item may take various other forms as well.

Yet further, the item-specific data may comprise an identification of the absence of data for a given punch item. By way of example, the item-assignment data may identify the absence of an assignee of a given punch item, or the lack of a response from the assignee of a punch item.

It should further be understood that item-specific data for a given punch item may also take various other forms.

As another possibility, the punch-item data for a given punch item may include project-specific data. This project-specific data may take also various forms.

For instance, project-specific data for a given punch item may comprise “project scope” data that indicates a scope of the construction project with which the given punch item is associated. As examples, such project scope data may include an indication of the project's area (e.g., square footage or square meters), the type of project (e.g., commercial, residential, etc.), the project's blueprints, the number of items in the punch list, a punch item's relative location in the punch list, the number of contractors working on the project, whether there are any drawings associated with the given punch item, etc. The project scope data for a given punch item may also take various other forms.

Further, project-specific data for a given punch item may comprise “project location” data for the construction project with which the given punch item is associated. As examples, such project location data may include an indication of the state, city, county, country, etc. in which the construction project is located. The project location data for a given punch item may take various other forms.

Further still, in an implementation, the punch-item data may take the form of properties data associated with other types of punch-item data. This properties data may take various forms. As one example, the properties data may comprise numerical properties such as a count of a given type of item-specific data, for instance, a count of a number of punch items in a punch list, a number of attachments, etc. According to another example, the properties data may take indicate the presence or absence of a given type of punch-item data, for instance the presence or absence of an assignee, a punch priority, reference, etc. The properties data may take other forms as well.

It should further be understood that project-specific data for a given punch item may take various other forms as well.

As yet another possibility, in cases where punch-item data includes text-based data for a given punch item, such punch-item data may also be updated to include or be associated with sentiment data for the given punch item, which indicates a sentiment that is derived from the text-based data for the given punch item. In one example, such sentiment data may have values such as “positive” or “negative.” In another example, such sentiment data may have values such as “positive,” “negative,” “very positive,” “very negative,” “neutral,” etc. It is also possible that the values of the sentiment data may be represented by numbers, such as integers. For example, a neutral sentiment may be represented by the number 0, a positive sentiment may be represented by the number +1, and a negative sentiment may be represented by the number −1. Sentiment data may take various forms and be represented in various other manners as well.

The punch-item data that is received as the predictive model's input may take various other forms as well.

Likewise, the output of the predictive model may take various forms. As one possibility, the predictive model's output may comprise a risk level associated with the given punch item, which indicates a risk of the punch item not being completed by the punch item's target completion date. In this respect, the predicted risk level may take any of various forms, and as one possible example, the risk level options may include a “low” risk level, a “medium” risk level, and a “high” risk level.

In practice, the risk level comprises an indication of when the given punch item is predicted to be completed relative to the given punch item's target completion data, which may be determined by the predictive model in various manners. In one implementation, the predictive model may determine the predicted risk level for the given punch item by (1) predicting a respective likelihood of the given punch list being completed in each of a plurality of different time frames, (2) selecting the time frame during which the given punch item is most likely to be completed, and (3) comparing the selected time frame to the given punch item's target completion date to determine the risk level.

For instance, if the predicted model predicts that the given punch item is most likely to be completed during at time frame that falls before the target completion date (which may include the target completion date itself), then the predictive model may output a predicted risk level of “low” for the given punch item. Alternatively, if the predicted model predicts that the given punch item is most likely to be completed during at time frame that falls shortly after the target completion date (e.g., 1-4 days after the target completion date), then the predictive model may output a predicted risk level of “medium” for the given punch item. Alternatively yet, if the predicted model predicts that the given punch item is most likely to be completed during at time frame that falls well after the target completion date (e.g., 5 or more days after the target completion date), then the predictive model may output a predicted risk level of “high” for the given punch item. The process by which the predictive model determines the predicted risk level—and the predicted risk level options that may be output by the predictive model—may take various other forms as well.

As another possibility, to the extent that the predictive model is configured to predict a respective likelihood of the given punch list being completed in each of a plurality of different time frames, the predictive model's output may optionally comprise an indication of the predicted likelihoods for these different time frames. For example, if the predictive model is configured to predict a respective likelihood of the given punch list being completed during (1) a first time frame that is before the target completion date (which may include the target completion date itself), (2) a second time frame that is shortly after the target completion date, and (3) a third time frame that is well after the completion date, the predictive model's output may optionally include a respective likelihood value for each of these three time frames.

As yet another possibility, the predictive model's output may optionally comprise a confidence level associated with predicted risk level for the given punch item, which indicates a confidence in the predictive model's prediction of the risk level for the given punch item. In this respect, the optional confidence level output by the predictive model may take various forms and be determined in various manners. In one implementation, the confidence level may be determined based on the respective likelihoods of the given punch item being completed in the different time frames. For example, the confidence level may be the predicted likelihood of the given punch item being completed in the selected time frame that corresponds to the predicted risk level (i.e., the time frame having the highest likelihood). Other examples are possible as well.

As still another possibility, the predictive model's output may include an indication of the particular aspect of the punch-item data for the given punch item that most likely led to the predictive model's output of the predicted risk level (e.g., lack of assignee).

The output of the predictive model may take various other forms as well.

The predictive model may take various other forms as well. For instance, instead of employing a single predictive model that is configured to predictive risk levels for the entire set of possible punch item types, the back-end platform may employ multiple different predictive models that are each configured to predictive risk level of a particular subset of possible punch item types. In this respect, the definition and executing phases described below may be carried out for each different predictive model.

As discussed above, the process for employing the predictive model to provide individuals responsible for overseeing a construction project with a prediction of a risk levels for punch items on a punch list may generally take place in multiple phases, including but not limited to (1) a definition phase during which the back-end platform defines the predictive model and (2) an execution phase during which the back-end platform inputs punch-item data for punch items into the predictive model and outputs predicted risk levels for such punch items. Each of these phases may take various forms.

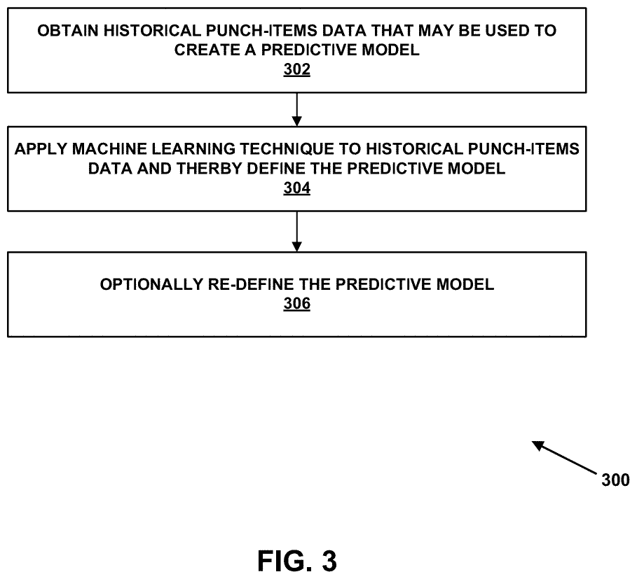

FIG. 3 is a flow diagram 300 that depicts one possible example of a definition phase that may be carried out by a back-end platform to define the disclosed predictive model. For purposes of illustration, the example process is described as being carried out by back-end platform 102, but this process may be carried out by other systems as well. It should be understood that flow diagram 300 is provided for sake of clarity and explanation and that numerous other combinations of functions may be utilized—including the possibility that example functions may be added, removed, rearranged into different orders, combined into fewer blocks, and/or separated into additional blocks depending upon the particular embodiment.

As shown in FIG. 3, the example definition phase may begin at block 302 with back-end platform 102 obtaining historical-punch-items data that may be used to create a predictive model. Such historical-punch-items data may take various forms. As one possibility, the historical-punch-items data may include (a) a respective punch item dataset (e.g., item-specific data, project-specific data, and/or sentiment data) for each of a plurality of past punch items that have completed and (b) a respective label associated with each of the plurality of past punch items that indicates when the past punch item was actually completed relative to its target completion date, which may be represented as an actual (i.e., observed) risk level of the past punch item. In this respect, the label for a past punch item may be generated by back-end system 102 based on a comparison between the actual completion date of the punch item to the target completion date of the punch item, and/or the label for a punch item may be input into back-end system 102 by a user, among other possibilities. The historical-punch-items data may take other forms as well.

It should also be understood that if a predictive model is configured to predict risk levels for a particular subset of punch item types, then the historical-punch-items data may be specific to those punch item types.

Further, back-end platform 102 may obtain the historical-punch-items data in various manners. As one possibility, back-end platform 102 may obtain the historical-punch-items data from a data store of back-end platform 102. As another possibility, back-end platform 102 may obtain the historical-punch-items data from a system that is external to back-end platform 102. Back-end platform 102 may obtain the historical-punch-items data in other manners as well.

At block 304, after obtaining the historical-punch-items data, back-end platform 102 may apply a machine learning technique to the historical-punch-items data and thereby define the predictive model. The machine learning technique that is used by back-end platform 102 may take any of various forms, including but not limited to a random forest technique, a gradient boosting technique (such as those implemented using the XGBoost library), and a logistic regression technique.

At a high level, the machine learning technique may analyze the historical-punch-items data to learn how various features (e.g., variables) included in the punch-item datasets for the past punch items are correlated to the time frame during which the past punch items were completed, and thus the risk level for the past punch items. Based on this analysis, back-end platform 102 may derive a relationship between (1) a given punch item's values of a given set of punch item variables and (2) a likelihood of the given punch item being completed in each of a plurality of different times. Back-end platform 102 may the embody this relationship into the predictive model that is used to predict a risk level of a punch item.

In some implementations, after applying the machine learning technique to the historical-punch-items data as discussed above, back-end platform 102 may also evaluate the relative contribution of the different punch item variables to the output of the predictive model, and for variables that do not contribute or contribute very little to the output of the predictive model, back-end platform 102 may choose not to include those variables as inputs. In this respect, back-end platform 102 may select punch item variables that are not to be included as inputs to the predictive model in various manners. As on example, back-end platform 102 may remove variables that have less than a minimum correlation value (e.g., an r² value). As another example, back-end platform 102 may remove variables in order of their correlation until a set (e.g., maximum) number of input variables for the predictive model is reached. Back-end platform 102 may remove input variables in various other manners as well.

In addition, after evaluating the relative contribution of the different punch item variables to the output of the predictive model, back-end platform 102 may use this information to output an indication of the aspect of the punch-item data that most likely led to the predicted risk level. For example, if lack of assignee is determined to contribute most to the predictive model's output and there is a lack of assignee reflected in the punch-item data for a given task item assigned a high risk level prediction, the predictive model may be used to determine that lack of assignee is the aspect of the punch-item data that most likely led to that high risk level prediction.

At block 306, back-end platform 102 may also optionally re-define the predictive model. The process of re-defining the predictive model may take various forms.

In one implementation, to re-define a predictive model, additional historical punch items data may be input into the predictive model defined in block 304 and the accuracy of the predictive model may be determined by comparing the predicted risk levels output by the predictive model to the actual completion dates of the punch items in the inputted additional historical punch items data. The function of determining the accuracy of the predictive model may take various forms.

In some instances, an automated function may compare the predicted risk levels to the actual completion dates of the punch items from the additional historical punch items data.

In another instance, a user may review the accuracy of the predictive model to determine whether to re-define the predictive model. This user review of the accuracy of a predictive model may also take various forms.

As one example, a user may review the accuracy of the predictive model using a confusion matrix, which may be generated by a computing device such as back-end platform 102 and/or client station 104A. The confusion matrix is a table that may allow visualization of the accuracy of the predictive model. According to one example, each column in the confusion matrix may represent an instance of a predicted risk level, while each row of the confusion matrix may represent an instance of an actual risk level (or vice versa).

In some examples, a confusion matrix may be used to visualize a percentage of punch items that were assigned incorrect risk labels. The confusion matrix may take other forms as well.

Based on the user-determined accuracy of the predictive model, which a user may determine based on the visualized percentage of incorrectly assigned risk labels, a user may instruct back-end platform 102 to re-define the predictive model. For example, based on the confusion matrix, a user may determine model parameters that should be changed or how those model parameter values should be changed when re-defining the model, and may then input that information into back-end platform 102.

If either a user or an automated function determines that the accuracy of the defined predictive model is too low, back-end platform 102 may re-define the predictive model using the same historical punch items data that was previously used to define the predictive model with respect to blocks with 302 and 304 in the same manner described above but using different model parameters to determine how the inputs contribute to the output of the predictive model.

In another implementation, if back-end platform 102 or a user determines that the accuracy of the predictive model defined in block 304 is too low, a new set of historical punch items data may be selected and input as training data to define a new predictive model based on that newly-selected set of historical punch items data. The process of re-defining a predictive model may take various other forms as well.

It should further be understood that process of executing a definition phase may take various other forms and carried out in various other manners as well.

After performing the definition phase to define a predictive model, back-end platform 102 may proceed to the execution phase and begin to execute the predictive model that was defined based on the historical punch items data.

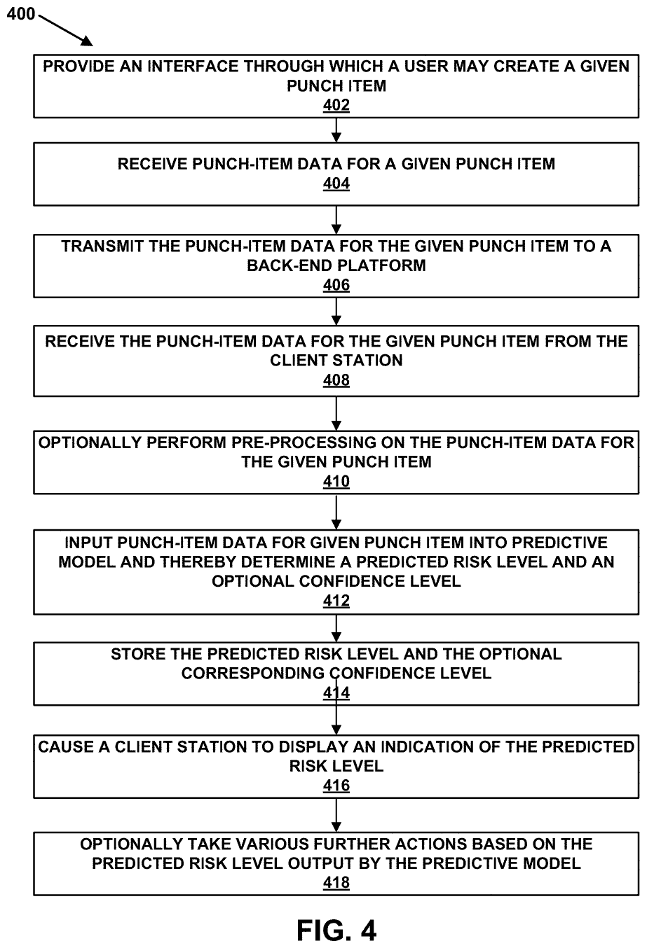

FIG. 4 is a flow diagram 400 that depicts one possible example of an execution phase that involves executing the disclosed predictive model to output a predicted risk level for a given punch item.

For purposes of illustration, the example process is described as being carried out by the entities in the example network configuration of FIG. 1, but this process may be carried out in other network configurations as well. It should be understood that flow diagram 400 is provided for sake of clarity and explanation and that numerous other combinations of functions may be utilized— including the possibility that example functions may be added, removed, rearranged into different orders, combined into fewer blocks, and/or separated into additional blocks depending upon the particular embodiment.

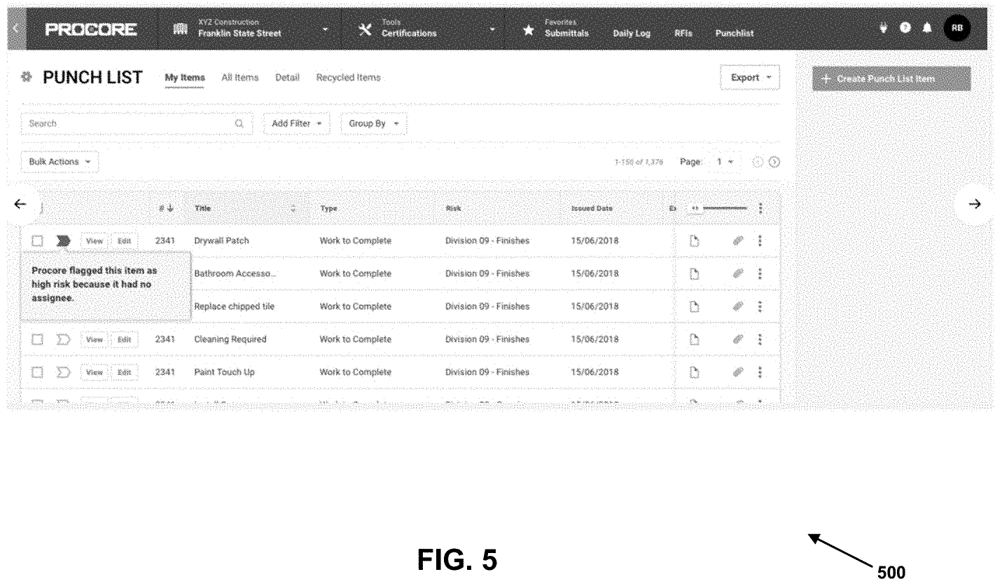

As shown in FIG. 4, the example execution phase may begin at block 402 with a client station (e.g., client station 104A) providing an interface through which a user may create a given punch item (e.g., by entering punch-item data for the given punch item). This interface may take various forms and be accessed in various manners. As one possibility, the interface may be included as part of an interactive front-end construction management software application running on the client station, in which case the interface may be provided after a user launches the front-end application on the client station and navigates to the interface for creating a punch list item. For example, if the front-end application includes a “Punch List” view such as the one illustrated in FIG. 5, a user may access the interface for creating a punch item by selecting the “Create Punch List Item” element. The interface for creating a punch item may take various other forms and/or be accessed in various other manners as well.

Further, the function of providing the interface at the client station may take various forms. In one example, the client station may provide the interface while running a native version of the front-end software application, in which case the client station may provide the interface without interacting with back-end platform 102. In another example, the client station may provide the interface while running a web version of the front-end software application, in which case the client station may send an HTTP request to back-end platform 102 and back-end platform 102 may then responsively transmit data and/or instructions that enable the client station to provide the interface (e.g., back-end platform 102 may provide the interface via the client station). Other examples are possible as well.

At block 404, while providing the interface, the client station may receive punch-item data for a given punch item. In one implementation, the client station may receive the punch-item data for the given punch item based on user input received at the client station. The punch-item data for the given punch item may generally take any of the forms described above.

In some implementations, after receiving the punch-item data for the given punch item via the interface, the client station may also derive and/or otherwise obtain additional punch-item data for the given punch item and include it with the punch-item data for the given punch item. For example, the client station may derive additional item-specific data for the given punch item, such as a season when work for the given punch item will be undertaken. As another example, the client station may obtain project-specific data for the given punch item that has previously been stored at the client station, such as square footage of the construction project with which the given punch item is associated. The client station may derive and/or obtain other types of data to include with the punch-item data for the given punch item as well.

At block 406, the client station may then transmit the punch-item data for the given punch item to back-end platform 102 over the respective communication link between the client station and back-end platform 102. In this respect, the client station may either send the punch-item data as soon as the user has finished creating the given punch item, or at some later time (e.g., if the client station does not have network connectivity with back-end platform 102 at the time that the punch item is created, it may be configured to send the punch-item data once network connectivity is restored).

At block 408, back-end platform 102 may then receive the punch-item data for the given punch item from the client station over the respective communication link. In turn, at block 410, back-end platform 102 may optionally perform pre-processing on the received punch-item data for the given punch item. This optional pre-processing may take various forms.

As one possibility, the optional pre-processing may involve restructuring and/or reformatting the given item data to place such data into a common format that is used by back-end platform 102.

As another possibility, the optional pre-processing may involve deriving or otherwise obtaining additional data to include with the punch-item data for the given punch item. For instance, in one implementation, back-end platform 102 may derive and/or obtain additional data similar to that described above with reference to the client station (e.g., season data, project data, etc.). In another implementation, back-end platform 102 may perform natural language processing or the like on text-based data included in the punch-item data for the given punch item to identify any sentiments included in that textual-based data, which may then be included and/or associated with the punch-item data for the given punch item. In this respect, the natural language processing may generally involve back-end platform 102 determining various words or phrases that are present in the text-based punch-item data for the given punch item, and based on those present words or phrases, determining whether any relevant sentiments are reflected.

In some examples, the associations between the words and their sentiments may be determined by back-end platform 102 from a dictionary of associated sentiments for words in a given language. Back-end platform 102 may also determine the sentiments for certain words that have context-specific meanings. For instance, back-end platform 102 may build and/or store a dictionary of construction project-specific words and their corresponding sentiments and may use this project-specific dictionary to determine the sentiments associated with words or phrases present in the punch-item data for the given punch item.

According to an implementation, each determined sentiment for a given word may have a corresponding value. Each determined sentiment for a given word may have various different values. In one example, the sentiment determined for a given word or phrase may be either positive or negative. In another example, the sentiment for a given word or phrase may comprise more than two possible sentiment values. For instance, the sentiment may be one of: extremely negative, negative, neutral, positive, or extremely positive, as some examples. In some examples, these sentiment values may also be represented by numbers, such as integers. For example, a neutral sentiment may be represented by the number 0, a positive sentiment may be represented by the number +1, and a negative sentiment may be represented by the number −1. Sentiment values may be represented in various other manners as well.

The sentiment values may comprise any combination or subset of these sentiment values or may take various other forms as well.

If back-end platform 102 does determine additional data to include or associate with the punch-item data for the given punch item, back-end platform 102 may then update the punch-item data for the given punch item to include or be associated with the sentiment data.

The process of performing pre-processing on the punch-item data for the given punch item may take various other forms and may be carried out in various other manners as well.

At block 412, after optionally performing pre-processing on the punch-item data for the given the punch item, back-end platform 102 may input the punch-item data for the given punch item into the defined predictive model, which may trigger the defined predictive model to output a predicted risk level (and an optional confidence level) for the given punch item. In this respect, if back-end platform 102 has multiple predictive models that are each configured to predict risk levels for a particular subset of punch item types, then back-end platform 102 may selected the predictive model to use based on the type of the given punch item.

At block 414, after outputting the predicted risk level for the given punch item, back-end platform 102 may store the predicted risk level and the optional corresponding confidence level together with the punch list data for the given punch item. In one implementation, back-end platform 102 may store this information as part of a record in a database, either by creating a new record for the given punch item or updating an existing database record for the given punch item to include or to be associated with the predicted risk level and optional confidence level.

Optionally, as part of outputting the predicted risk level for the given punch item, back-end platform 102 may identify an aspect of the punch-item data for the given punch item that most likely led to the predicted risk level (i.e., the most-likely reason for the predicted risk level). In one implementation, back-end platform 102 may determine the reason for the predicted risk level based on data indicating the relative contribution of each of the punch-item variables included in the punch-item data for the given punch item to the output of the predictive model. Back-end platform 102 may store the determined reason as part of a record in a database for the given punch item. Back-end platform 102 may determine the reason for the predicted risk level in various other manners as well.

At block 416, back-end platform 102 may also cause a client station, such as client station 106A, to display an indication of the predicted risk level for the given punch item. The function of causing client station 106A to display the indication of the risk level may take various forms.

In an implementation where back-end platform 102 received punch-item data for the given punch item from a client station (e.g. client station 104A), back-end platform 102 may be configured to respond to the client station with an instruction to display the indication of the predicted risk level for the given punch item. In some examples, such an instruction may cause back-end platform 102 to display the indication of the predicted risk level for the given punch item as part of an updated “Punch List” view.

In another implementation, back-end platform 102 may send an instruction to display the indication of the predicted risk level for the given punch item in response to receiving a later request from a client station to view information about the given punch item (e.g., a request to display a “Punch List” view), which may either be sent by the same client station at which the given punch item was created or some other client station.

In turn, the manner in which a client station displays the indication of the predicted risk level may take various forms. As one possibility, a client station may display an indicator in a “Punch List” view for each punch item included in the punch list (or a punch item-specific view) that indicates the predicted risk level of the associated punch item. Such an indicator may take various forms and represent different risk levels in various manners. As one example, the indicator may be a graphic indicator that has a different color and/or a different shape depending on the predicted risk level being represented. As another example, the indicator may be a text-based indicator that has a different text value (and perhaps a different color) depending on the predicted risk level being represented. The indicator of the predicted risk levels may take other forms as well.

It should also be understood that the different forms of the indicator may correspond to the different risk level options in various manners. In one example, the indicator may take a different form for each different risk level. As another example, the indicator may take a form that corresponds to multiple different risk levels. For instance, the indicator may have two possible forms, where a first form corresponds to both high and medium risk levels and a second form corresponds to a low risk level. Other examples are possible as well.

Further, in an interface such as a “Punch List” view that includes a list of multiple punch items, the predicted risk levels of the punch items in such an interface may be used to dictate the manner in which the punch items are displayed.

According to one implementation, back-end platform 102 may be configured to transmit an instruction that causes the punch items in the punch list to be displayed in a “Punch List” view (or the like) based on the items' predicted risk levels. For example, the punch items displayed in the “Punch List” view may be sorted from highest risk level to lowest risk level (or vice versa).

According to another implementation, a “Punch List” view may include a user-selectable control element that may cause the punch items in the punch list to be sorted based on their predicted risk levels. In this respect, the function of updating the interface to display the sorted punch items may be carried out the client station either alone or in combination with back-end platform 102.

The predicted risk levels of punch items in a “Punch List”-type view may be used to dictate the manner in which the punch items are displayed in other manners as well (e.g., by grouping punch items according to risk level).

At block 418, back-end platform 102 may optionally take various further actions based on the predicted risk level output by the predictive model. For instance, such further actions may take the form of generating and/or transmitting a message, such as notification, alert, etc., to a client station associated with an individual responsible for the construction project with which the given punch item is associated. In this respect, the individual to which the message is sent may be determined based on the punch-item data for the given punch item, among other possibilities. The further actions may take various other forms as well.

In one implementation, the actions may be taken based on meeting a certain criterion that may be related to the predicted risk level. For example, an action may be taken if the risk level meets a certain level, such as “medium,” or “high.” The actions may be taken based on various other factors as well.

The process of performing the execution phase may take various other forms and may be carried out in various other manners as well.

Turning back now to the interfaces at a client station described above, a client station or another computing device may execute a front-end application that provides an interface, which may comprise various views. Examples of these views will now be illustrated and described in greater detail.

Turning now to FIG. 5, a conceptual diagram of an example “Punch List” view 500 is illustrated. In the example of FIG. 5, a plurality of punch list items are displayed in the view. In the illustrated implementation of the view, each punch item in the punch list is represented on a separate row. Further, a representation of punch-item data for each punch item is displayed for each punch item displayed in the punch list.

In the illustrated example, each punch item includes graphical elements corresponding to the following fields, which may comprise punch-item data: a category number, title, a type of item, a risk type, an issued date, a risk flag, and a reason for the risk flag. The risk flag field is a graphical element which may indicate whether the associated punch item is at risk of not being completed by its respective target completion date.

In the illustrated example of FIG. 5, the first punch item in the punch list has its associated risk flag indicator filled and color-coded differently (e.g., red), which indicates the first punch item is at high risk. Additionally, the risk flag may be associated with another user interface element that indicates the most likely reason for the high risk level prediction. In the depicted example of FIG. 5, the reason for the risk flag may be that the first punch item in the punch list lacks an assignee.

Further, the various punch items illustrated in FIG. 5 may be sortable based on the field values of each column by way of a control element associated with each field. In an implementation illustrated in the example of FIG. 5, punch items may be sortable by risk level, title, type, risk, issued date, or any other field value. In an example, the controls that sort each respective field may be present at the top of the table of punch items.

Further, the punch list view of FIG. 5 also includes a GUI element 504 that takes the form of a button control labeled “Create Punch List Item.” A user may select the create punch list item control to enter a different view, such as a “Create Punch Item” view as described above.

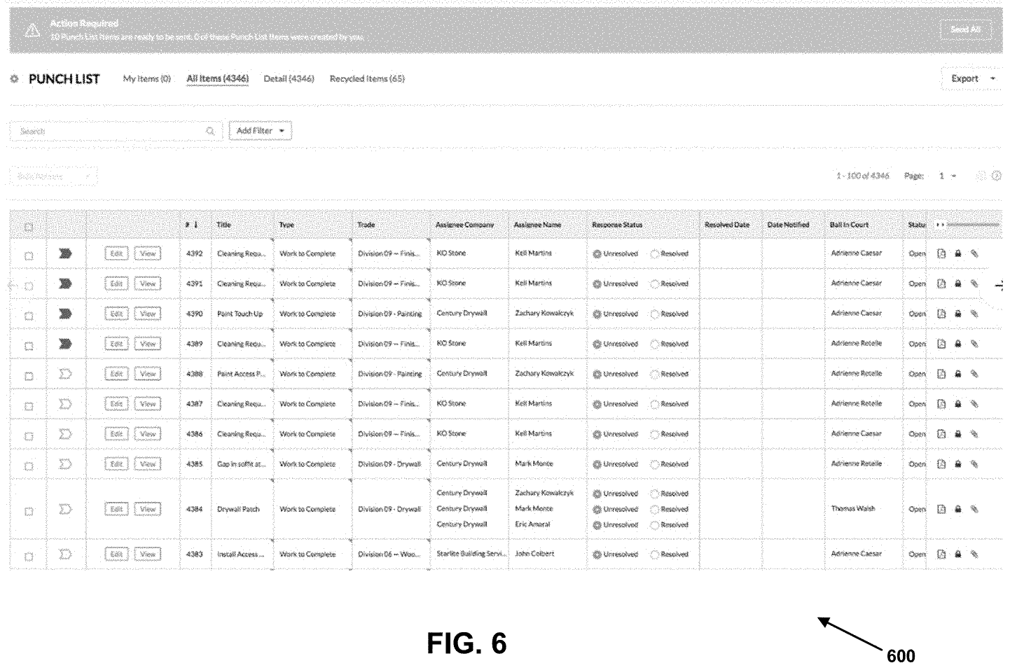

Turning now to FIG. 6, another conceptual diagram of an example “Punch List” view 600 is illustrated. In the example of FIG. 6, graphical representations of a plurality of punch list items are displayed in the illustrated punch list view 600. In the illustrated implementation of the “Punch List” view, punch-item data for each given punch item in the punch list is represented on a separate row.

In the illustrated example, each punch item includes a category number, title, a type, a trade, an assignee company, an assignee name, a response status, a received date, a date notified, a ball in court, a status, and a risk flag field. The risk flag field for each associated punch item may indicate whether that associated punch item is at risk of not being completed by its respective target completion date. In the illustrated example of FIG. 6, each of the punch items is sorted based on the risk level associated with each punch item from highest to lowest risk. Thus, the first four rows have a risk flag that is filled and color-coded differently (e.g., red), indicating each of the first four punch items is at risk for missing its respective target completion date (i.e., high or medium risk), whereas rows five and onward have risk flags that are not filled or color-coded, indicating that the punch items in rows five and onward have a low risk level.

It should be understood that the punch list views illustrated in FIGS. 5 and 6 may include more or fewer elements, and may take various other forms, appearances, etc.

### V. CONCLUSION

Example embodiments of the disclosed innovations have been described above. Those skilled in the art will understand, however, that changes and modifications may be made to the embodiments described without departing from the true scope and sprit of the present invention, which will be defined by the claims.

For instance, those in the art will understand that the disclosed approach for predicting risk level may be implemented in other construction-related areas. As one possibility, a back-end platform may also be configured to receive data pertaining to submittals, in which case the back-end platform may be configured to use the modeling approaches disclosed herein to evaluate risk for those submittals. For example, a back-end platform may be configured to define and then execute a predictive model that is used to determine whether a submittal is likely to result in late completion. As another example, a back-end platform may be configured to define and then execute a predictive model that is used to determine other areas of risk associated with the submittal, such as the amount of time it takes for a submittal to be approved, the length of time it takes to respond to the submittal, and so forth. The disclosed approach for predicting risk level could be used in other contexts as well.

Further, to the extent that examples described herein involve operations performed or initiated by actors, such as “humans,” “operators,” “users” or other entities, this is for purposes of example and explanation only. The claims should not be construed as requiring action by such actors unless explicitly recited in the claim language.

1. A computing platform comprising:
a network interface;
at least one processor;
a non-transitory computer-readable medium; and
program instructions stored on the non-transitory computer-readable medium that are executable by the at least one processor such that the computing platform is configured to:
cause a first client station to display a user interface for creating punch items for a construction project by inputting data defining punch-items;
receive, from the first client station, respective punch-item data defining each of a plurality of punch items,
for each punch item in the plurality of punch items, derive, based on the received punch-item data, additional punch-item data, wherein (i) the received punch-item data and (ii) the derived additional punch-item data for each punch item comprise a respective set of punch-item variables;
for each punch item in the plurality of punch items, apply a trained machine learning model to analyze the punch item's respective punch-item data and thereby determine a predicted risk level that indicates a likelihood of the punch item not being completed by a target completion date for the punch item;
determine, based on applying the trained machine learning model, a given punch item for which the predicted risk level meets a threshold level;
identify, for the given punch item, a given punch-item variable of the respective punch-item data that indicates a reason for the predicted risk level for the given punch item; and
cause a second client station to display a representation of the plurality of punch items that includes:
an identification of each punch item;
an indicator of each punch item's respective predicted risk level; and
for the given punch item and any other punch items for which the respective predicted risk level meets the threshold level, an indication of a respective reason for the respective predicted risk level.

2. The computing platform of claim 1, further comprising program instructions stored on the non-transitory computer-readable medium that are executable by the at least one processor such that the computing platform is configured to:
train a machine learning model by carrying out a machine learning process on a training data set that includes historical punch-item data, wherein the trained machine learning model is configured to (i) receive, as input, data defining a punch item, (ii) based on an evaluation of the data defining the punch item, output a predicted risk level for the punch item, and (iii) identify which one or more variables of the data defining the punch item contributed most to the predicted risk level for the punch item.

3. The computing platform of claim 2, wherein the historical punch-item data comprises (i) respective data defining each of a plurality of completed punch items and (ii) a respective label for each of the plurality of completed punch items that indicates an actual completion date of the completed punch item relative to a target completion date of the completed punch item.

4. The computing platform of claim 1, wherein the program instructions that are executable by the at least one processor such that the computing platform is configured to determine the predicted risk level for each punch item comprise program instructions that are executable by the at least one processor such that the computing platform is configured to:
determine a predicted future time during which the punch item is most likely to be completed; and
based at least on (i) the predicted future time during which the punch item is most likely to be completed and (ii) the target completion date of the punch item, determine the respective predicted risk level for the punch item.

5. The computing platform of claim 4, further comprising program instructions stored on the non-transitory computer-readable medium that are executable by the at least one processor such that the computing platform is configured to:
predict a respective likelihood of the punch item being completed in each of a plurality of different future times,
wherein the program instructions that are executable by the at least one processor such that the computing platform is configured to determine the predicted future time during which the punch item is most likely to be completed comprise program instructions that are executable by the at least one processor such that the computing platform is configured to determine, from the plurality of future times, a given future time corresponding to a highest likelihood of the punch item being completed.

6. The computing platform of claim 1, wherein the program instructions that are executable by the at least one processor such that the computing platform is configured to identify the given variable of the respective punch-item data that indicates the reason for the predicted risk level for the given punch item comprise program instructions that are executable by the at least one processor such that the computing platform is configured to:
identify one or more punch-item variables of the respective punch-item data for the given punch item that contributed to the predicted risk level for the given punch item;
evaluate each identified punch-item variable's respective contribution to the predicted risk level for the given punch item; and
determine which of the identified one or more variables contributed most to the respective predicted risk level for the given punch item.

7. The computing platform of claim 1, further comprising program instructions stored on the non-transitory computer-readable medium that are executable by the at least one processor such that the computing platform is configured to:
for each punch item in the plurality of punch items, store (i) the respective punch-item data for the punch item and (ii) the respective predicted risk level for the punch item; and
for the given punch item and any other punch items for which the respective predicted risk level meets the threshold level, store the respective reason for the respective predicted risk level.

8. The computing platform of claim 1, further comprising program instructions stored on the non-transitory computer-readable medium that are executable by the at least one processor such that the computing platform is configured to:
for each punch item in the plurality of punch items, determine a respective confidence level associated with the punch item's respective predicted risk level; and
cause the second client station to display an indication of the respective confidence level associated with the punch item's respective predicted risk level.

9. The computing platform of claim 1, wherein the trained machine learning model comprises one of (i) a random forest classifier model, (i) a gradient boosting model, or (iii) a logistic regression model.

10. The computing platform of claim 1, further comprising program instructions stored on the non-transitory computer-readable medium that are executable by the at least one processor such that the computing platform is configured to:
re-train the trained machine learning model using one or both of (i) newly-available historical punch-item data or (ii) modified model parameters for the trained machine learning model.

11. The computing platform of claim 1, wherein the received punch-item data for each punch item comprises one or both of (i) item-specific data for the punch item or (ii) project-specific data for the punch item.

12. The computing platform of claim 1, wherein the derived additional punch-item data for each punch item comprises one or more of (i) item-specific punch-item data, (ii) project-specific punch-item data, (iii) timing punch-item data, (iv) sentiment punch-item data, or (v) data determined via one or more natural language processing (NLP) techniques.

13. A non-transitory computer-readable medium, wherein the non-transitory computer-readable medium is provisioned with program instructions that, when executed by at least one processor, cause a computing platform to:
cause a first client station to display a user interface for creating punch items for a construction project by inputting data defining punch-items;
receive, from the first client station, respective punch-item data defining each of a plurality of punch items,
for each punch item in the plurality of punch items, derive, based on the received punch-item data, additional punch-item data, wherein (i) the received punch-item data and (ii) the derived additional punch-item data for each punch item comprise a respective set of punch-item variables;
for each punch item in the plurality of punch items, apply a trained machine learning model to analyze the punch item's respective punch-item data and thereby determine a predicted risk level that indicates a likelihood of the punch item not being completed by a target completion date for the punch item;
determine, based on applying the trained machine learning model, a given punch item for which the predicted risk level meets a threshold level;
identify, for the given punch item, a given punch-item variable of the respective punch-item data that indicates a reason for the predicted risk level for the given punch item; and
cause a second client station to display a representation of the plurality of punch items that includes:
an identification of each punch item;
an indicator of each punch item's respective predicted risk level; and
for the given punch item and any other punch items for which the respective predicted risk level meets the threshold level, an indication of a respective reason for the respective predicted risk level.

14. The non-transitory computer-readable medium of claim 13, wherein the non-transitory computer-readable medium is also provisioned with program instructions that, when executed by at least one processor, cause the computing platform to:
train a machine learning model by carrying out a machine learning process on a training data set that includes historical punch-item data, wherein the trained machine learning model is configured to (i) receive, as input, data defining a punch item, (ii) based on an evaluation of the data defining the punch item, output a predicted risk level for the punch item, and (iii) identify which one or more variables of the data defining the punch item contributed most to the predicted risk level for the punch item.

15. The non-transitory computer-readable medium of claim 14, wherein the historical punch-item data comprises (i) respective data defining each of a plurality of completed punch items and (ii) a respective label for each of the plurality of completed punch items that indicates an actual completion date of the completed punch item relative to a target completion date of the completed punch item.

16. The non-transitory computer-readable medium of claim 13, wherein the program instructions that, when executed by at least one processor, cause the computing platform to determine the predicted risk level for each punch item comprise program instructions that, when executed by at least one processor, cause the computing platform to:
determine a predicted future time during which the punch item is most likely to be completed; and
based at least on (i) the predicted future time during which the punch item is most likely to be completed and (ii) the target completion date of the punch item, determine the respective predicted risk level for the punch item.

17. The non-transitory computer-readable medium of claim 16, wherein the non-transitory computer-readable medium is also provisioned with program instructions that, when executed by at least one processor, cause the computing platform to:
predict a respective likelihood of the punch item being completed in each of a plurality of different future times,
wherein the program instructions that are executable by the at least one processor such that the computing platform is configured to determine the predicted future time during which the punch item is most likely to be completed comprise program instructions that are executable by the at least one processor such that the computing platform is configured to determine, from the plurality of future times, a given future time corresponding to a highest likelihood of the punch item being completed.

18. The non-transitory computer-readable medium of claim 13, wherein the program instructions that, when executed by at least one processor, cause the computing platform to identify the given variable of the respective punch-item data that indicates the reason for the predicted risk level for the given punch item comprise program instructions that, when executed by at least one processor, cause the computing platform to:
identify one or more punch-item variables of the respective punch-item data for the given punch item that contributed to the predicted risk level for the given punch item;
evaluate each identified punch-item variable's respective contribution to the predicted risk level for the given punch item; and
determine which of the identified one or more variables contributed most to the respective predicted risk level for the given punch item.

19. A method carried out by a computing platform, the method comprising:
causing a first client station to display a user interface for creating punch items for a construction project by inputting data defining punch-items;
receiving, from the first client station, respective punch-item data defining each of a plurality of punch items,
for each punch item in the plurality of punch items, deriving, based on the received punch-item data, additional punch-item data, wherein (i) the received punch-item data and (ii) the derived additional punch-item data for each punch item comprise a respective set of punch-item variables;
for each punch item in the plurality of punch items, applying a trained machine learning model to analyze the punch item's respective punch-item data and thereby determine a predicted risk level that indicates a likelihood of the punch item not being completed by a target completion date for the punch item;
determining, based on applying the trained machine learning model, a given punch item for which the predicted risk level meets a threshold level;
identifying, for the given punch item, a given punch-item variable of the respective punch-item data that indicates a reason for the predicted risk level for the given punch item; and
causing a second client station to display a representation of the plurality of punch items that includes:
an identification of each punch item;
an indicator of each punch item's respective predicted risk level; and
for the given punch item and any other punch items for which the respective predicted risk level meets the threshold level, an indication of a respective reason for the respective predicted risk level.

20. The method of claim 19, further comprising:
training a machine learning model by carrying out a machine learning process on a training data set that includes historical punch-item data, wherein the trained machine learning model is configured to (i) receive, as input, data defining a punch item, (ii) based on an evaluation of the data defining the punch item, output a predicted risk level for the punch item, and (iii) identify which one or more variables of the data defining the punch item contributed most to the predicted risk level for the punch item.
